(19) United States
(12) Patent Application Publication
(10) Pub. No.: US 2008/0252140 A1
(43) Pub. Date: Oct. 16, 2008

(54) VALVE FOR ANTI-LOCK BRAKE SYSTEM

(75) Inventor: Chung Jae Lee, Gyeonggi-do (KR)

Correspondence Address: LADAS & PARRY, 5670 WILSHIRE BOULEVARD, SUITE 2100, LOS ANGELES, CA, 90036-5679, US

(73) Assignee: MANDO CORPORATION, Gyeonggi-do (KR)

(21) Appl. No.: 12/041,067

(22) Filed: Mar. 3, 2008

(30) Foreign Application Priority Data
Apr. 12, 2007 (KR) 10-2007-35839

(51) Int. Cl. B60T 8/34

(52) U.S. Cl. 303/119.2; 137/511

(57) ABSTRACT

A valve for an anti-lock brake system in which a structure of a valve housing is modified, thereby reducing the manufacturing cost. The valve for the anti-lock brake system includes a valve core, an armature, which is disposed below the valve core and has a spherical member installed at an end of the armature, a cylindrical sleeve which is coupled at an outer circumference of the valve core and the armature to allow the armature to move forward and backward, a first elastic member installed between the valve core and the armature, a valve housing, which is coupled at an end of the cylindrical sleeve and is formed therein with a hollow section extending lengthwise along the valve housing, a seat plunger, which is installed in the hollow section to move forward and backward and is formed with a first orifice that is opened/closed by the spherical member, a second elastic member installed between an upper end of the seat plunger and a lower end of the valve housing, and a filter seat, which is provided at an outer circumference and a lower portion thereof with an inlet and an outlet, respectively, and is press-fitted into a lower outer circumferential portion of the valve housing.

### CROSS-REFERENCE TO RELATED APPLICATION

This application claims the benefit of Korean Patent Application No. 10-2007-0035839 filed on Apr. 12, 2007, in the Korean Intellectual Property Office, the disclosure of which is incorporated herein by reference.

### BACKGROUND OF THE INVENTION

1. Field of the Invention

The present invention relates to a valve for an anti-lock brake system. More particularly, the present invention relates to a valve for an anti-lock brake system, in which a structure of valve housing is modified, thereby reducing the manufacturing cost.

2. Description of the Related Art

In general, a hydraulic brake for a vehicle accomplishes a braking operation through oil pressure applied to a master cylinder corresponding to an operation of a brake pedal. In this case, if a braking force applied to a tire is greater than a static friction force between a road surface and the tire, the tire may slip on the road.

However, since the kinetic friction coefficient is smaller than the static friction coefficient, the slip phenomenon must be prevented to achieve an optimum braking performance. In addition, a handle locking phenomenon in which a handle is not controlled upon the braking operation must be prevented.

An Anti-lock Brake System (ABS) has been suggested to prevent the above handle locking phenomenon by controlling the hydraulic pressure applied to the master cylinder. The ABS basically includes a plurality of solenoid valves, an ECU for controlling the solenoid valves, an accumulator and a hydraulic pump.

Referring to FIG. 1, the conventional solenoid valve is installed on a modulator block 1 to increase an integration degree, and a valve bore 2 is formed in the modulator block 1 to install the valve therein.

A hollow valve housing 3, which is formed with an inlet 3a and an outlet 3b communicated with an inner fluid path formed in the modulator 1, is installed in the valve bore 2.

A cylindrical sleeve 5 is coupled with one end of the valve housing 3 such that an armature 4 installed in the cylindrical sleeve 5 may move forward and backward. A valve core 6 is coupled to an open end of the sleeve 5 to block the open end of the sleeve 5 and to allow the armature 4 to move forward and backward.

In addition, the armature 4 extends toward a valve seat 7, which is installed in a hollow section, to open/close an orifice 7a of the valve seat 7 through a reciprocation movement. In addition, an elastic member 8 is installed between the armature 4 and the valve core 6 to provide elasticity to the armature 4.

Such a conventional solenoid valve has a structure in which the valve housing 3 is provided with the inlet 3a and the outlet 3b forming an entrance and an exit, respectively, and the valve seat 7 is press-fitted in the valve housing 3.

However, according to the above structure, since the valve seat 7 is installed in the valve housing 3, the size of the valve is enlarged. In addition, since the inlet 3a and the outlet 3b must be formed in a radial direction and a length direction, a complicated cutting process is necessary to manufacture the valve housing 3.

Such an increase in size of the modulator block 1 and the complicated cutting process cause an increase of the manufacturing cost for the anti-lock brake system.

### SUMMARY OF THE INVENTION

Accordingly, it is an aspect of the present invention to provide a solenoid valve for an anti-lock brake system, capable of obtaining a compact structure and simplifying the cutting process, thereby reducing the manufacturing cost.

Additional aspects and/or advantages of the invention will be set forth in part in the description which follows and, in part, will be apparent from the description, or may be learned by practice of the invention.

The foregoing and/or other aspects of the present invention are achieved by providing a solenoid valve for an anti-lock brake system comprising a valve core, an armature, which is disposed below the valve core and has a spherical member installed at an end of the armature, a cylindrical sleeve which is coupled at an outer circumference of the valve core and the armature to allow the armature to move forward and backward, a first elastic member installed between the valve core and the armature, a valve housing, which is coupled at an end of the cylindrical sleeve and is formed therein with a hollow section extending lengthwise along the valve housing, a seat plunger, which is installed in the hollow section to move forward and backward and is formed with a first orifice that is opened/closed by the spherical member, a second elastic member installed between an upper end of the seat plunger and a lower end of the valve housing, and a filter seat, which is provided at an outer circumference and a lower portion thereof with an inlet and an outlet, respectively, and is press-fitted into a lower outer circumferential portion of the valve housing.

According to an aspect of the present invention, a filter member is installed in the inlet to filter fluid.

According to an aspect of the present invention, a second orifice, which is opened/closed according to forward/backward movement of the seat plunger, is installed in the outlet of the filter seat.

According to an aspect of the present invention, a seat bush having a second orifice, which is opened/closed according to forward/backward movement of the seat plunger, is press-fitted into the outlet of the filter seat.

According to an aspect of the present invention, a fixing member having a ring shape is installed between the valve housing and the filter seat to support a lower portion of the elastic member

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a sectional view representing a structure of a conventional valve for an anti-lock brake system;

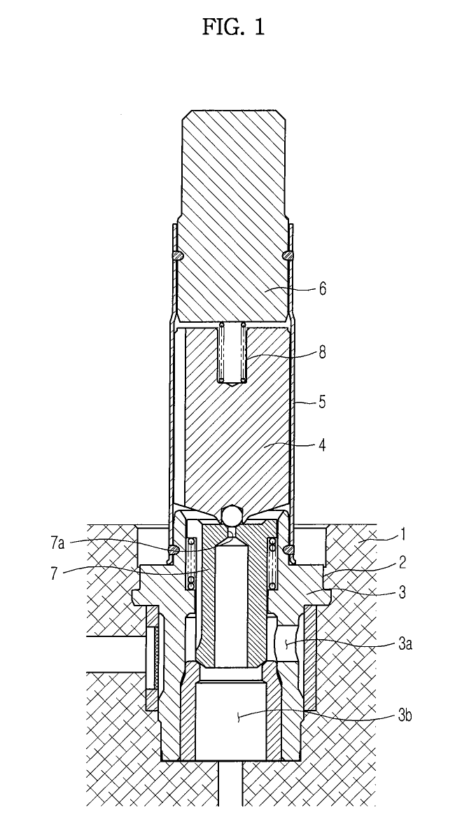

FIG. 2 is a sectional view representing a structure of a valve for an ant-lock brake system according to an embodiment of the present invention;

FIG. 3 is a sectional view representing a structure of a valve for an anti-lock brake system according to another embodiment of the present invention; and

FIG. 4 is a sectional view representing a structure of a valve for an anti-lock brake system according to still another embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

Hereinafter, a preferred embodiment of the present invention will be described in detail with reference to the accompanying drawings.

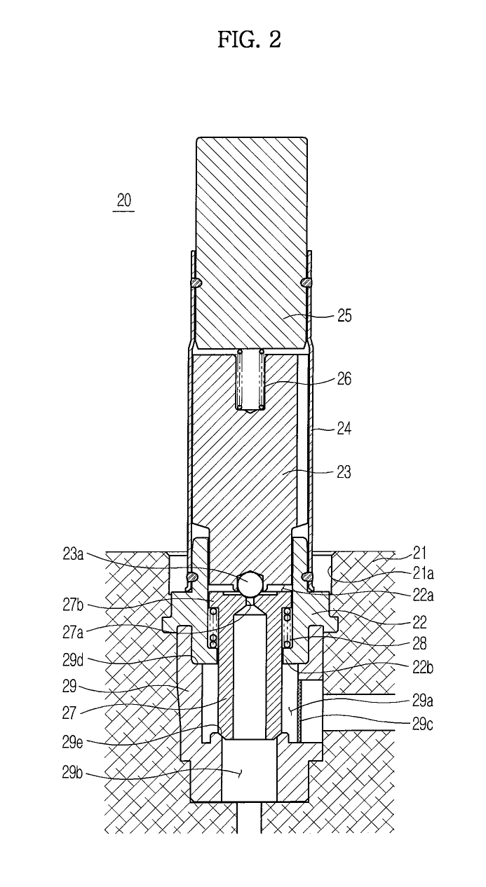

As shown in FIG. 2, a solenoid valve 20 for an ant-lock brake system according to the present invention is provided with a valve housing 22, which is press-fitted in a bore 21a of a modulator block 21.

A cylindrical sleeve 24 is coupled to one end of the valve housing 22 such that an armature 23 installed in the cylindrical sleeve 24 may move forward and backward. A valve core 25 is coupled to an open end of the sleeve 24 to block the open end of the sleeve 24 and allow the armature 23 to move forward and backward.

A first elastic member 26 is installed between the valve core 25 and the armature 23 to apply elastic force to the armature 23 in the downward direction, and a spherical member 23a is installed at a lower end of the armature 23.

A hollow section 22a is formed lengthwise along the valve housing 22 to allow the armature 23 to move forward and backward. A seat plunger 27 having a first orifice 27a, which is opened/closed by the spherical member 23a according to the forward/backward movement of the armature 23, is installed below the armature 23.

The seat plunger 27 is supported such that the seat plunger 27 moves forward and backward through the hollow section 22a similarly to the armature 23. A second elastic member 28 is installed between a lower end of the valve housing 22 and the seat plunger 27 to apply elastic force to the seat plunger 27 in the upward direction.

A flange portion 27b for installing the second elastic member 28 radially extends from an upper end of the seat plunger 27 to support an upper end of the second elastic member 28 and to close the hollow section 22a. A flange portion 22b is formed at a lower end of the hollow section 22a of the valve housing 22. The second elastic member 28 has an elastic coefficient smaller than that of the first elasticity member 26.

In addition, a filter seat 29 having an inlet 29a and an outlet 29b of the valve 20 is installed at a lower portion of the valve housing 22.

The inlet 29a and the outlet 29b are formed in a radial direction and in a length direction of the filter seat 29, respectively. A filtering member 29c is installed in the inlet 29a to filter fluid.

An inner circumferential portion of the filter seat 29 is press-fitted into a lower outer circumferential portion of the valve housing 22 while maintaining an air-tightness state therebetween. A stepped protrusion 29d is formed at an upper inner circumferential portion of the filter seat 29 so as to define a press-fitting position and to reinforce sealing force by ensuring a wide contact area between the valve housing 22 and the filter seat 29.

The outlet 29b formed at a lower portion of the filter seat 29 has an upper end that forms a second orifice 29e which is opened/closed according to the forward/backward movement of the seat plunger 27.

The second orifice 29e communicates with the first orifice 27a, and has a diameter slightly larger than that of a lower end of the seat plunger 27. The lower end of the seat plunger 27 is inserted into the second orifice 29e to block a fluid path between the inlet 29a and the outlet 29b. The inlet 29a and the outlet 29b are directly connected to each other when the seat plunger 27 is moved up.

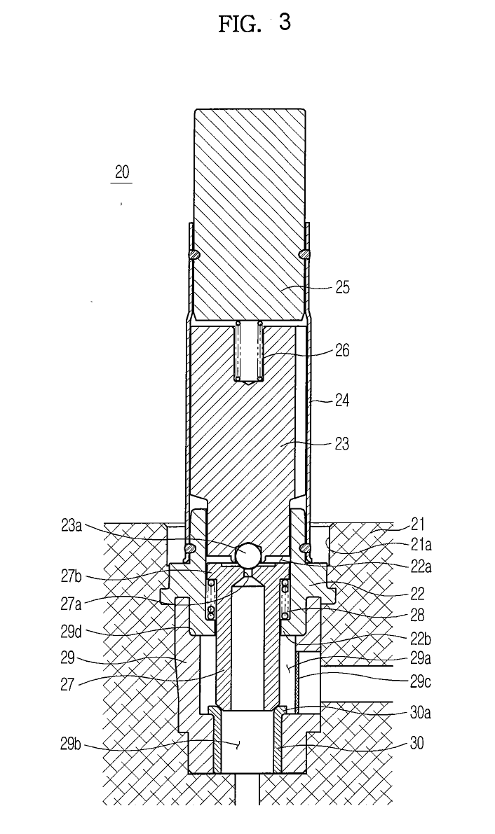

FIG. 3 represents another embodiment of the present invention. When forming the second orifice in the filter seat 29, a pattern for forming the second orifice is not completely formed on the filter seat 29, but a hollow section for forming the outlet 29b is formed in the filter seat 29 and then a seat bush 30 for forming a second orifice 30a is press-fitted into the hollow section.

Accordingly, since the seat bush 30 having a shape, which can be easily fabricated through a plastic process, is installed, the cutting process can be omitted as compared with the case in which the second orifice is directly formed in the filter seat 29, thereby reducing the manufacturing cost.

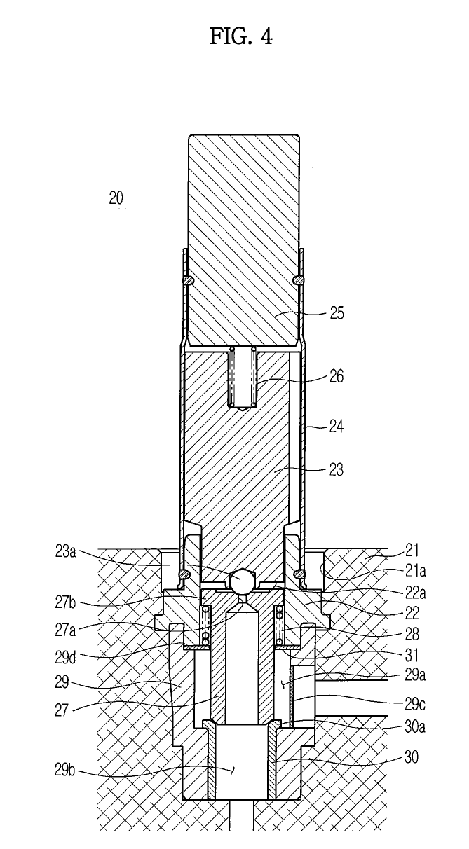

FIG. 4 represents still another embodiment of the present invention. This embodiment is different from the above embodiment in that a fixing member 31 having a ring shape is interposed between the valve housing 22 and the filter seat 29 to form a flange structure for supporting the lower end of the second elastic member 28.

The fixing member 31 is mounted on the stepped protrusion 29d formed on the filter seat 29 such that the fixing member 31 can be pressed when the filter seat 29 is press-fitted into the valve housing 22.

If such a fixing member 31 is employed, the cutting process for the flange portion can be omitted in addition to the process for forming the hollow section in the process of forming the valve housing 22, so that the manufacturing cost of the valve housing can be reduced.

Hereinafter, an opening/closing operation of the valve for the ant-lock brake system having the above structure according to the present invention will be described.

In a normal operation, since the first elastic member 26 has the elastic coefficient greater than that of the second elastic member 28, the armature 23 moves toward the seat plunger 27 so that the first orifice 27a is closed by the spherical member 23a.

Upon an operation of the valve 20, the armature 23 moves back toward the valve core 25 so that the first orifice 27a is open. At this time, since high braking pressure is applied to the inlet 29a, the armature 23 may move back prior to the seat plunger 27 due to a pressure difference between the inlet 29a and the outlet 29b, thereby opening the first orifice 27a.

After that, if the fluid passes through the first orifice 27a such that the pressure difference between the inlet 29a and the outlet 29b is maintained below a predetermined level, the seat plunger 27 is moved up by the second elastic member 28 so that the second orifice 29e is open. Accordingly, the inlet 29a is directly connected to the outlet 29b, so that a large quantity of fluid flows toward the outlet 29b, thereby rapidly increasing the pressure in a hydraulic line.

As described above, according to the valve for the anti-lock brake system of the present invention, the valve includes a valve housing, a seat plunger installed at a lower portion of the valve housing and a filter seat, which is coupled to the outer circumference of the valve housing and the seat plunger and is formed with the inlet and the outlet.

Accordingly, the valve housing can be designed into a compact structure, the components of the valve housing can be easily assembled with each other, and the shape of the valve is simplified, so that the cutting process for forming a complicating shape can be omitted, thereby reducing the manufacturing cost.

Although few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A valve for an anti-lock brake system, the valve comprising:
a valve core;
an armature, which is disposed below the valve core and has a spherical member installed at an end of the armature;
a cylindrical sleeve which is coupled at an outer circumference of the valve core and the armature to allow the armature to move forward and backward;
a first elastic member installed between the valve core and the armature;
a valve housing, which is coupled at an end of the cylindrical sleeve and is formed therein with a hollow section extending lengthwise along the valve housing;
a seat plunger, which is installed in the hollow section to move forward and backward and is formed with a first orifice that is opened/closed by the spherical member;
a second elastic member installed between an upper end of the seat plunger and a lower end of the valve housing; and
a filter seat, which is provided at an outer circumference and a lower portion thereof with an inlet and an outlet, respectively, and is press-fitted into a lower outer circumferential portion of the valve housing.

2. The valve as claimed in claim 1, wherein a filter member is installed in the inlet to filter fluid.

3. The valve as claimed in claim 1, wherein a second orifice, which is opened/closed according to forward/backward movement of the seat plunger, is installed in the outlet of the filter seat.

4. The valve as claimed in claim 1, wherein a seat bush having a second orifice, which is opened/closed according to forward/backward movement of the seat plunger, is press-fitted into the outlet of the filter seat.

5. The valve as claimed in claim 1, wherein a fixing member having a ring shape is installed between the valve housing and the filter seat to support a lower portion of the elastic member.
